(19) United States
(12) Patent Application Publication
(10) Pub. No.: US 2013/0151956 A1
(43) Pub. Date: Jun. 13, 2013

(54) AUTOCORRECT CONFIRMATION SYSTEM

(71) Applicant: Corville O. Allen, Morrisville, NC (US)

(72) Inventor: Corville O. Allen, Morrisville, NC (US)

(73) Assignee: INTERNATIONAL BUSINESS MACHINES CORPORATION, Armonk, NY (US)

(21) Appl. No.: 13/315,664

(22) Filed: Dec. 9, 2011

(51) Int. Cl. G06F 17/21

(52) U.S. Cl. 715/256

(57) ABSTRACT

An embodiment of a system for accepting or rejecting changes made to a message is described. The system includes a user interface for receiving input and displaying a change made by an autocorrect application on a display device. The system further includes a confirmation manager for creating a record of changes made to a message by the autocorrect application. The system further includes a system for processing instructions to send the message to another device. The system for processing send instructions is configured to receive a command to send a message to another device. The system displays on a display device the change made by the autocorrect application. The change includes a word prior to and after the change has been made. The system further prompts a user to accept or reject the change made by the autocorrect application.

### BACKGROUND

Many electronic devices, including desktops, laptops, and mobile devices have applications for composing and sending messages to other devices. Many of these messaging applications allow users to quickly compose and send a message to another electronic device. To prevent typos and other errors, many applications for composing and sending messages include autocorrect features or applications for correcting typos and enabling users to type commonly used words more rapidly in composing and transmitting messages.

While autocorrect applications permit users to more rapidly communicate between electronic devices, they oftentimes erroneously correct words or phrases without confirmation of a user or in such a way that the user overlooks the automatic corrections made by the application. In many cases, these automatic corrections may change the meaning of a phrase, oftentimes resulting in a message that makes little sense or may be potentially offensive.

### SUMMARY

An embodiment of a system for accepting or rejecting changes made to a message is described. The system includes a user interface for receiving input and displaying a change made by an autocorrect application on a display device. The system further includes a confirmation manager for creating a record of changes made to a message by the autocorrect application. The system further includes a system for processing instructions to send the message to another device. The system for processing instructions is configured to receive a command to send a message to another device. The system displays the change made by the autocorrect application. The change includes a word prior to and after the change has been made. The system further prompts a user to accept or reject the change made by the autocorrect application.

Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

FIG. 1 depicts a schematic diagram of one embodiment of a system for confirming changes made to a message by an autocorrect application.

FIG. 2 depicts a schematic diagram of one embodiment of a user device used in a system for confirming changes made to a message by an autocorrect application.

FIG. 3A depicts one embodiment of a display of a user device that incorporates a system for confirming a change made to a message by an autocorrect application.

FIG. 3B depicts one embodiment of a display of a user device that incorporates a system for confirming multiple changes made to a message by an autocorrect application.

FIG. 4 depicts one embodiment of a method for confirming a change made to a message by an autocorrect application.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

While many embodiments are described herein, at least some of the described embodiments include a device for confirming corrections made to a message by an autocorrect application. In one embodiment, a user may compose a message in an application that uses an autocorrect function. The autocorrect function makes changes to words or phrases in a message, and the device tracks those changes and permits the user to either accept or reject the changes prior to transmitting the message to another device. If the user accepts the changes made by the autocorrect function, the device transmits the message with the incorporated changes to another device over a network. If the user rejects the changes, the device allows the user to return to the message and make any desired changes, including manually reversing or adjusting the changes made by the autocorrect function prior to transmitting the message to another device.

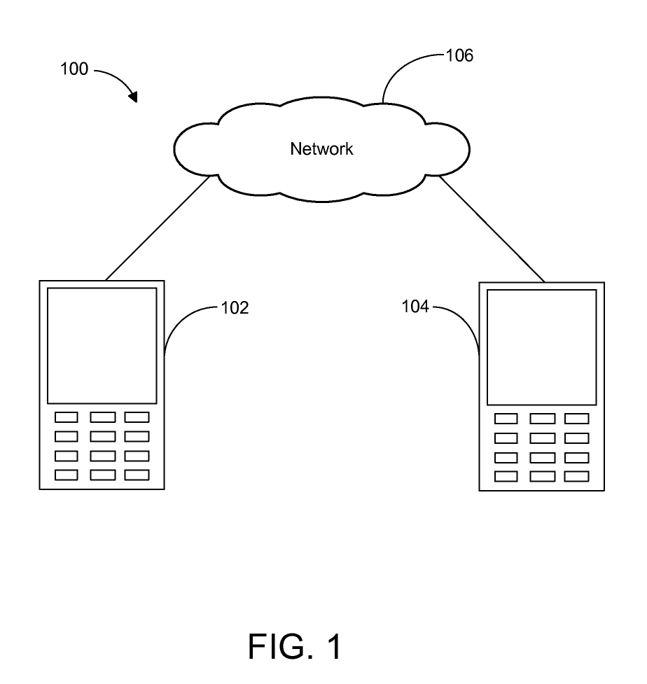

FIG. 1 depicts a schematic diagram of one embodiment of a system 100 for confirming changes made to a message by an autocorrect application. The system 100 includes a first user device 102 capable of composing and sending a message to a second device 104 over a network 106. The devices 102, 104 may be any type of electronic device for transmitting messages, such as, for example, a mobile device, a desktop computer, a laptop, a touchpad, or any electronic device capable of composing and electronically sending a message. Also, the devices 102, 104 need not be similar devices, but may transmit messages between completely different devices, such as, for example, between a mobile phone and a desktop computer over a network 106. Further, the network 106 may be any type of network for communication between multiple devices, such as a LAN, WLAN, intranet, Internet, or combination thereof.

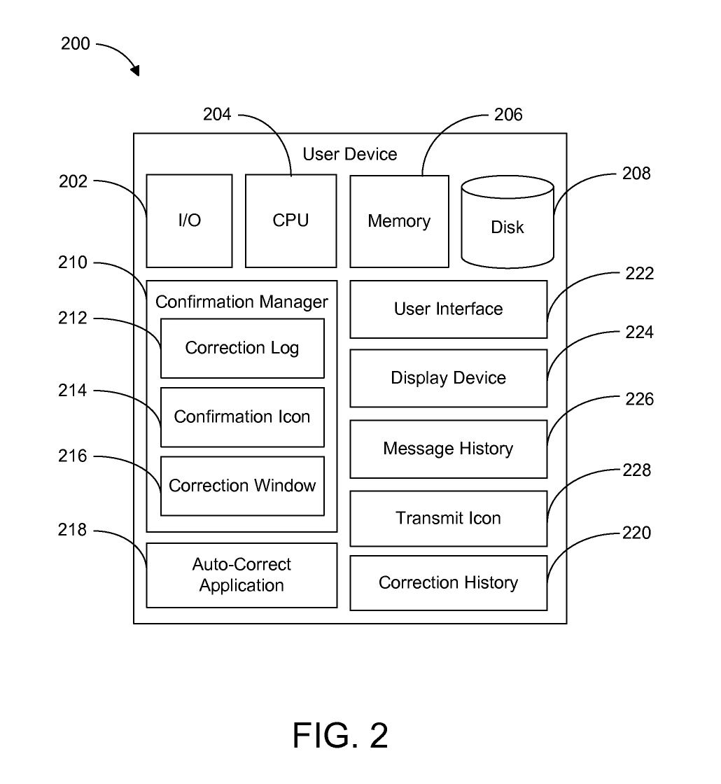

FIG. 2 depicts a schematic diagram of one embodiment of a user device 200 to be used in a system 100 for confirming changes made to a message by an autocorrect application 218. The device 200 includes an I/O interface 202, a processor 204, a memory 206 and a disk 208. The user device 200 further includes a display device 224 for displaying a message and other data to a user. In some embodiments, the display device 224 may be physically separate from other components of the user device 200 or may in some cases be attached or integral to the device 200.

In one embodiment, the device 200 includes a user interface 222 to enable a user to compose a message and confirm or reject changes made by an autocorrect application 218 to a message. In at least one embodiment, the device 200 makes use of one or more electronic input devices such as an electronic keyboard, mouse, touch screen, or other device for receiving input from a user. Further, each of the input devices that make up the I/O interface 102 and/or user interface 222 may be integral to the user device 200, such as an on-board keyboard or touch screen, or may be on separate components altogether, such as a wireless keyboard, mouse, or other input device for interacting with or sending input to the user device 200.

In one embodiment, the user device 200 utilizes an autocorrect application 218. The autocorrect application 218 makes changes to a message as it is composed by a user. In some cases, the autocorrect application 218 makes changes to words or phrases of a message automatically in the course of composing a message. In some cases, an autocorrect application 218 makes suggestions for words, names or phrases that are common to a particular user or device 200, permitting a user to enter a word or phrase without entering each letter of that word or phrase. Some autocorrect applications 218 make changes primarily for grammatical errors or to correct words that are may not be recognized by a database on the device 100. Some autocorrect applications 218 may fill in words or phrases automatically while other applications 218 may require additional input from a user as the message is being composed.

When a message is composed, and the autocorrect application 218 has made or suggested changes to words of the message, the device 200 utilizes a confirmation manager 210 that creates a correction history 220 or record of the changes made by the autocorrect application 218. The correction history 220 tracks the metadata and other information associated with each of the words that make up a message, including whether or not a particular word or phrase has been affected by the autocorrect application 218. The correction history 220 may further include data related to the original word prior to being changed by the autocorrect application 218 as well as data related to the word after being changed by the autocorrect application 218.

In addition to creating a record or history of corrections 220 made to the words of a message, the confirmation manager 210 may be configured to identify whether or not any words of a message have been changed by the autocorrect application 218. In some embodiments, this identification of changed words or phrases may be done upon selection of the user prior to completing the message or may be triggered by a command to send the message to another device 200. The confirmation manager 210 may interrupt transmission of a message or be configured to recognize a correction made by the autocorrection application 218 as part of the process of receiving and processing instructions to send a message to another device.

Upon identification of a change made by the autocorrect application 218, the confirmation manager 212 is configured to prompt a user to accept or reject one or more changes made to a word or phrase of the message. In prompting a user to accept or reject the changes, the confirmation manager 210 displays the changes in a correction window 216. The changes may be displayed on the display device 224 as a list or correction log 212 in a correction window 216. In some embodiments, the correction window 216 displays each of the words prior to being changed by the autocorrect application 218 as well a corresponding word after it has been changed by the autocorrect application 218. In some embodiments, the changes may be displayed as a list, displaying each of the words before and after being changed by the autocorrect application 218.

In addition to displaying the original and corrected words in a correction window 212, some embodiments of the confirmation manager 210 may display one or more confirmation icons 214 corresponding to the words affected by the autocorrect application 218. In at least one embodiment, the confirmation icons 214 may be displayed as a list corresponding to a list of original and changed words, where each change performed by the autocorrect application 218 has a corresponding confirmation icon 214. In other embodiments, a single confirmation icon 214 may be displayed enabling a user to accept or reject all of the changes collectively without accepting or rejecting each of the changes individually. In some embodiments, a confirmation window 216 may display both the list of confirmation icons 214 corresponding to individual changes as well as the single confirmation icon 214 to accept or reject all of the changes collectively. A user may accept or reject a change by the autocorrection application 218 by selecting the displayed confirmation icon 214 with an input device. A user may also accept or reject a change by the autocorrection application 218 in other ways, such as deselecting, or even failing to select a confirmation icon 214, depending on relevant software instructions or particular display options.

Upon accepting of the changes made by the autocorrection application 218 by selecting the confirmation icon 214, the user device 200 may then transmit the message with the autocorrection changes to another device over a network 106. In this case, where the changes made by the autocorrection application 218 have been confirmed by the user, the transmitted message includes the changes made by the autocorrection application 218. In some cases, the correction history 220 and other information related to the message or metadata of words within the message may be deleted or discarded, and the user device 200 may then create a new record of changes 220 made to future messages by the autocorrection application 218.

If the user rejects the changes, either collectively or individually, by selecting, deselecting, or failing to select at least one confirmation icon 214, the user device 200 may be configured to return to a composing window of the message for further composition or editing of the message. A user may then change the words to their state prior to being changed by the autocorrection application 218 or change the message in any way in preparation for transmission to another device. In at least one embodiment, rather than returning to the message, a user may select the confirmation icon 214 to indicate a rejection of a change, also indicating that the word be changed back to the original word prior to being changed by the autocorrect application 218. In this embodiment, a user would not always return to edit a message, but may select or choose to transmit a message to another device by only changing a specific word to its pre-corrected state.

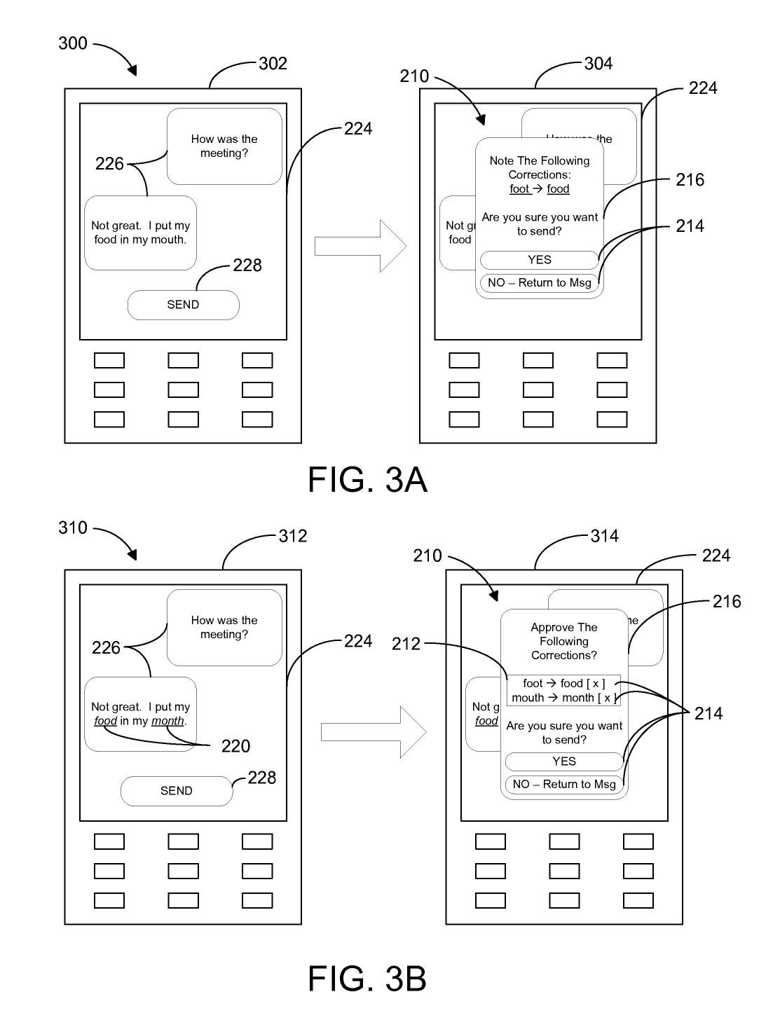

FIG. 3A depicts one embodiment of a display 224 of a user device 300 that incorporates the system 100 for confirming a change made to the message by the autocorrect application 218. The first display 302 includes a message history 226 between two users in which a remote user asks a question “How was the meeting?” The user of the device 300 attempts to respond “Not great, I put my foot in my mouth.” In the illustrated example, an autocorrect application 218 changes the word “foot” to “food” based on relevant software instructing the autocorrect application 218. While composing the message and implementing the autocorrection application 218, the device 300 creates a record of changes made to the message by the autocorrection application 218. A user then selects a transmit icon 228 indicating a command to send the message to the remote user.

When the user issues the command to send the message, the confirmation manager 210 on the device 300 displays on a display device the record of changes or correction history 220 to indicate words changed by the autocorrect application 218. In the illustrated embodiment, the confirmation manager 210 then opens a correction window 216 as illustrated on the second display 304. The correction window 216 displays a log of corrections 212 made by the autocorrect application 218, including the word before and after changes made via the autocorrection application 218. In the illustrated example, the confirmation log 212 indicates that the word “food” was originally “foot” when entered by the user, and that the autocorrect application 218 automatically changed the word “foot” to “food” with or without permission of the user. The confirmation manager 210 includes a plurality of confirmation icons 214, allowing a user to either accept or reject the indicated changes made by the autocorrection application 218. A user may then accept the changes by selecting the ‘yes’ icon 214, transmitting the message to the remote user. A user may alternatively select the ‘no’ icon 214, returning the user to compose or further edit the message. While the illustrated embodiment indicates that the user is returned to edit or further compose the message, some embodiments may simply reject one or more of the autocorrection changes and send the message with the original words or phrases prior to modification by the autocorrection application 218.

FIG. 3B depicts one embodiment of a display 224 of a user device 310 that incorporates a system 100 for confirming multiple changes made to a message by an autocorrect application 218. The first display 312 includes a message history 226 between two users similar to the message history of FIG. 3A. While composing the message, the device 310 creates a record of words changed by the autocorrect application 218, and in some cases provides a visual illustration of the changes made by the autocorrect application 218. The illustrated display 312 provides a visual illustration of the correction history 220 by underlining and italicizing the words affected by the autocorrect application 218. The device 200 may visually indicate the correction history 220 to a user in other ways, such as highlighting, coloring text, changing the font, or any other method of marking changes made to a word or phrase of a message. A user may then issue a command to send the message by selecting the transmit icon 228. A user may alternatively command the device 200 to send the message in other ways, such as pressing a button, selecting an icon, giving a voice command, or any other method for issuing a command on an electronic device 200.

When a user issues a command to send the message, the confirmation manager 210 on the device 310 recalls data from the record of changes or correction history 220 indicating words changed by an autocorrect application 218. In the illustrated embodiment, two words have been changed by the autocorrect application 218. In response to the question “How was the meeting?” the user of the device 310 responds by typing “Not great. I put my foot in my mouth.” The autocorrect application 218, using an algorithm to correct words of the message, replaces the word “foot” with “food” and the word “mouth” with “month.” In some embodiments, the autocorrect application 218 may visually note the words changed by the autocorrect application 218 for the user to more easily see which words have been changed.

When the user gives a send command or selects the transmit icon 228, the confirmation manager 210 opens a correction window 216 shown on the second display 314 of the device 310. Where there are multiple corrections made by the autocorrect application 218, the confirmation manager 210 may create and display a list of corrections 212 made by the autocorrect application 218, as illustrated in the second display 314. The confirmation manager 210 may further provide a list of confirmation icons 214 where each confirmation icon 214 corresponds to a specific change made by the autocorrect application 218.

In the illustrated display 314, the confirmation manager 210 provides multiple confirmation icons 214 for accepting or rejecting the changes made by an autocorrect application 218. For example, the confirmation icons 214 corresponding to each of the changes may be selected, deselected, or left blank to accept or reject a specific correction. In the illustrated embodiment, each of the confirmation icons 214 have been selected to indicate that both corrections made by the autocorrect application 218 were made erroneously and should be reversed prior to or upon transmission of the message. In some embodiments, a device 200 may be configured to send the message upon recognizing a user accepting each of the changes by selecting all of the confirmation icons 214. In some embodiments, a user may accept some changes and reject other changes and then select another confirmation icon 214 indicating a desire to send the message incorporating certain changes and rejecting other changes made by the autocorrect application 218. A user may also decide to return to the message by clicking a confirmation icon 214 that indicates rejection of the changes and a desire to return to the message to further compose or make changes to the message. In some embodiments, a confirmation icon 214 may indicate acceptance or rejection of all of the changes by the autocorrect application 218 collectively, rather than going through and individually selecting or deselecting specific changed made by the autocorrection application 218.

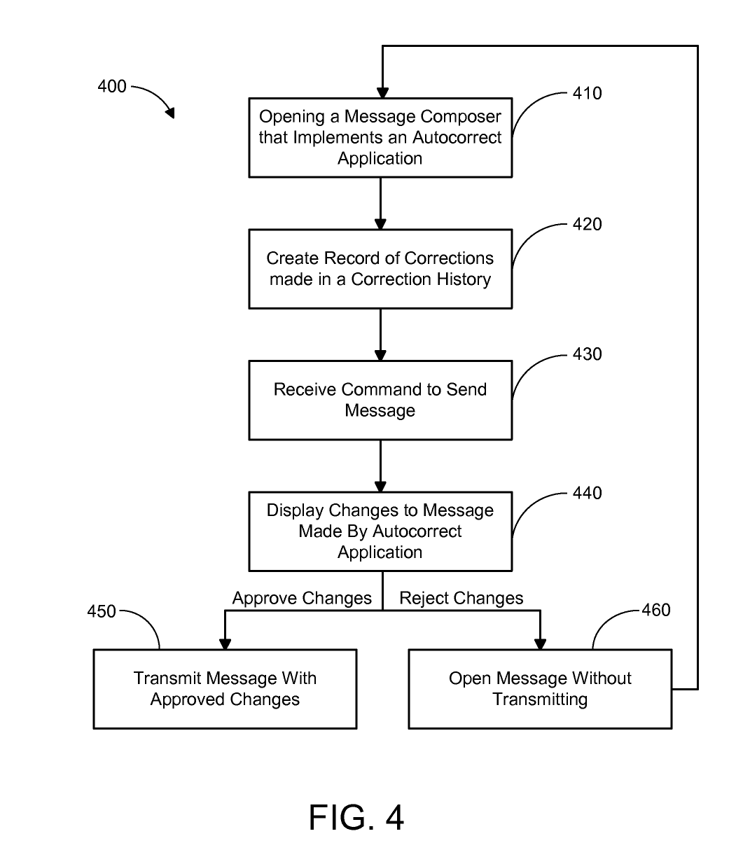

FIG. 4 depicts one embodiment of a method 400 for confirming a change made to a message by the autocorrect application 218. The method 400 includes opening 410 a message composer that implements an autocorrect application 218. A message may be drafted or composed in the message composer on any electronic device capable of transmitting messages to other devices. In some cases, the autocorrection application 218 may be automatically implemented without input or confirmation from the user.

During or after a user composes a message, a device 200 creates 420 a record or correction history 220 of changes made via the autocorrect application 218. In some embodiments, the device tracks metadata of each of the words of the message, including whether a change has been made to a specific word, including making a record 220 of what the original word was prior to correction as well as the resulting word after being changed by the autocorrect application 218. In some embodiments, the autocorrection application 218 may make changes automatically without input from a user. In other applications, the autocorrect application 218 may finish commonly used words or provide suggestions that a user selects to facilitate faster composition of a message.

The device 200 then receives 430 a command from a user to transmit the message to another device. When the user issues the command to send the message, the device 200 is configured to recognize at least one change that has been made by the autocorrect application 218. If there have been any changes, a confirmation manager 210 on the device 200 is configured provide an opportunity for a user to confirm those changes made by the autocorrect application 218.

The confirmation manager 210 allows a user to confirm any autocorrect changes by displaying 440 each of the changes on a display device 224. A user may then view each of the changes, including the original word prior to being changed as well as the word after the change has been made by the autocorrect application 218. The display of changes 212 may be a single change or list of changes, where a user may scroll through the changes and either accept or reject the changes to each of the words by selecting a confirmation icon 214 in a correction window 216. In some embodiments a user may accept all of the changes collectively or may go through a list of changes and select individual confirmation icons 214 corresponding to each change by the autocorrect application 218.

Where a user has approved or accepted the changes made by the autocorrect application 218, the device transmits 450 the message with the approved changes to another device. In this case, the message incorporates some or all of the changes made and disregards the original words prior to being affected by the autocorrect application 218. In some embodiments where a user has approved only certain changes, rejecting others, the device 200 may be configured to revert any rejected changes to their original status prior to being changed while keeping the approved words in their corrected state. In this case, even without returning to the message composer, the user may transmit the message to another device notwithstanding the rejection of some changes to the message.

Where a user has rejected changes made by the autocorrect application 218, the user or software may prompt the device to open 460 the message for editing without transmitting the message to another device. A user may then further compose the message or manually change the words of the message to comply with their intended spelling or meaning. In some embodiments, a user may reject messages made by the autocorrect application 218 and immediately transmit the message without returning to the message. In other embodiments, a user may reject the changes and disregard the message completely by selecting the confirmation icon 214. In some embodiments, upon returning to the message, the device 200 may begin the method 400 from the preparation stage of the message and continue tracking and creating a record of changes made by the autocorrect application 218.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

Although specific embodiments of the invention have been described and illustrated, the invention is not to be limited to the specific forms or arrangements of parts so described and illustrated. The scope of the invention is to be defined by the claims appended hereto and their equivalents.

An embodiment of a system for confirming corrections by an autocorrect application includes at least one processor coupled directly or indirectly to memory elements through a system bus such as a data, address, and/or control bus. The memory elements can include local memory employed during actual execution of the program code, bulk storage, and cache memories which provide temporary storage of at least some program code in order to reduce the number of times code must be retrieved from bulk storage during execution.

It should also be noted that at least some of the operations for the methods may be implemented using software instructions stored on a computer useable storage medium for execution by a computer. As an example, an embodiment of a computer program product includes a computer useable storage medium to store a computer readable program that, when executed on a processor within a computer, causes the computer to perform the operations described herein.

Embodiments of the invention can take the form of an entirely hardware embodiment, an entirely software embodiment, or an embodiment containing both hardware and software elements. In one embodiment, the invention is implemented in software, which includes but is not limited to firmware, resident software, microcode, etc.

Furthermore, embodiments of the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The computer-useable or computer-readable medium can be an electronic, magnetic, optical, electromagnetic, infrared, or semiconductor system (or apparatus or device), or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

Input/output or I/O devices (including but not limited to keyboards, displays, pointing devices, etc.) can be coupled to the system either directly or through intervening I/O controllers. Additionally, network adapters also may be coupled to the system to enable the data processing system to become coupled to other data processing systems or remote printers or storage devices through intervening private or public networks. Modems, cable modems, and Ethernet cards are just a few of the currently available types of network adapters.

What is claimed is:

1. A computer program product comprising a computer readable storage medium to store a computer readable program that, when executed on a processor within a computer, causes the computer to perform operations for confirming or rejecting changes made to a message, the operations comprising:
generating a record of a change made by an autocorrect application to the message; and
processing instructions to send a message to another device, wherein processing the instructions to send the message comprises:
receiving a command to send the message to another device;
displaying on a display device the change made by the autocorrect application, wherein displaying the change comprises displaying a word prior to the change made by the autocorrect application and displaying the word after the change has been made to the word by the autocorrect application; and
prompting a user to accept or reject the change made by the autocorrect application.

2. The computer program product of claim 1, wherein processing the instructions to send the message further comprises:
recognizing an acceptance of the change made by the autocorrect application; and
transmitting the message to another device over a network, wherein the message includes the change made by the autocorrect application.

3. The computer program product of claim 1, wherein processing the instructions to send the message further comprises:
recognizing a rejection of the change made by the autocorrect application; and
opening the message in a composing state to allow the user to edit the message.

4. The computer program product of claim 1, wherein the computer readable program, when executed on the processor within the computer, causes the computer to perform additional operations comprising:
displaying on the display device a selectable icon corresponding to the change corrected by the autocorrect application; and
recognizing a selection of the selectable icon as an acceptance or rejection of the change made by the autocorrect application.

5. The computer program product of claim 1, wherein the computer readable program, when executed on the processor within a computer, causes the computer to perform additional operations comprising:
displaying on the display device a list of a plurality of changes made by the autocorrect application, wherein the list comprises each word prior to the change made by the autocorrect application and a corresponding word after the change made by the autocorrect application.

6. The computer program product of claim 5, wherein the list of the plurality of changes further comprises a plurality of selectable icons, wherein each selectable icon corresponds to at least one of the plurality of changes made by the autocorrect application, and wherein the computer readable program, when executed on the processor within the computer, causes the computer to perform additional operations comprising:
recognizing the selection of each selectable icon as an acceptance or rejection of each corresponding change made by the autocorrect application.

7. A method for accepting or rejecting changes made to a message, comprising:
generating a record of a change made by an autocorrect application to the message; and
processing instructions to send a message to another device, wherein processing the instructions to send the message comprises:
receiving a command to send the message to another device;
displaying on a display device the change made by the autocorrect application, wherein displaying the change comprises displaying a word prior to the change made by the autocorrect application and displaying the word after the change has been made to the word by the autocorrect application; and
prompting a user to accept or reject the change made by the autocorrect application.

8. The method of claim 7, the method further comprising:
recognizing an acceptance of the change made by the autocorrect application; and
transmitting the message to another device over a network, wherein the message includes the change made by the autocorrect application.

9. The method of claim 7, the method further comprising:
recognizing a rejection of the change made by the autocorrect application; and
opening the message in a composing state to allow the user to edit the message.

10. The method of claim 7, further comprising:
displaying on the display device a selectable icon corresponding to the change corrected by the autocorrect application; and
recognizing a selection of the selectable icon as an acceptance or rejection of the change made by the autocorrect application.

11. The method of claim 7, further comprising displaying on the display device a list of a plurality of changes made by the autocorrect application, wherein the list comprises each word prior to the change made by the autocorrect application and a corresponding word after the change made by the autocorrect application.

12. The method of claim 11, wherein the list of the plurality of changes further comprises a plurality of selectable icons, wherein each selectable icon corresponds to at least one of the plurality of changes made by the autocorrect application, and wherein the method further comprises:
recognizing the selection of each selectable icon as an acceptance of rejection of each corresponding change made by the autocorrect application.

13. A system for accepting or rejecting changes made to a message, comprising:
a user interface for receiving input and displaying a change made by an autocorrect application on a display device;
a confirmation manager for creating a record of changes made to a message by the autocorrect application; and
a system for processing instructions to send the message to another device, wherein the system is configured to:
receive a command to send the message to another device;
display on a display device the change made by the autocorrect application, wherein displaying the change comprises displaying a word prior to the change made by the autocorrect application and displaying the word after the change has been made to the word by the autocorrect application; and
prompt a user to accept or reject the change made by the autocorrect application.

14. The system of claim 13, wherein the system for processing instructions is further configured to:
recognize an acceptance of the change made by the autocorrect application; and
transmit the message to another device over a network, wherein the message includes the change made by the autocorrect application.

15. The system of claim 13, wherein the system for processing of instructions is further configured to:
recognize a rejection of the change made by the autocorrect application; and
open the message in a composing state to allow the user to edit the message.

16. The system of claim 13, wherein the system for processing instructions is further configured to:
display on the display device a selectable icon corresponding to the change corrected by the autocorrect application; and
recognize a selection of the selectable icon as an acceptance or rejection of the change made by the autocorrect application.

17. The system of claim 13, wherein the system for processing of instructions is further configured to display on the display device a list of a plurality of changes made by the autocorrect application, wherein the list comprises each word prior to the change made by the autocorrect application and a corresponding word after the change made by the autocorrect application.

18. The system of claim 17, wherein the list of the plurality of changes further comprises a plurality of selectable icons, wherein each selectable icon corresponds to at least one of the plurality of changes made by the autocorrect application, and wherein the system for processing instructions is further configured to:
Recognize the selection of each selectable icon as an acceptance or rejection of each corresponding change made by the autocorrect application.
